(19) United States
(12) Patent Application Publication
(10) Pub. No.: US 2002/0101420 A1
(43) Pub. Date: Aug. 1, 2002

(54) Triangle shading method for a 3D graphic system

(75) Inventors: Hung-Ta Pai, Tai Chung County (TW); Ming-Tsan Kao, Kao Hsiung (TW)

Correspondence Address: BACON & THOMAS, PLLC, 625 SLATERS LANE, FOURTH FLOOR, ALEXANDRIA, VA, 22314

(73) Assignee: Silicon Integrated Systems Corp., Hsinchu (TW)

(21) Appl. No.: 10/054,922

(22) Filed: Jan. 25, 2002

(30) Foreign Application Priority Data
Jan. 29, 2001 (TW) 90101725

(51) Int. Cl. G06T 15/50; G06T 15/60

(52) U.S. Cl. 345/426

(57) ABSTRACT

A triangle shading method for a 3D graphic system includes the steps of (1) defining a starting position and two adjacent edges; (2) setting the tile containing the starting position as a target tile, then defining a target tile row; (3) checking if the lower boundary or upper boundary of the target tile crosses with the adjacent edges and pushing the address of crossing points into a stack if there exists such crossing points; (4) storing the associated data of the pixels of the target tile in memory; (5) checking if the target tile is the final tile of the target tile row, if not, setting the target tile to be the next tile of the current target tile and jumping to step (4); (6) checking if there are data remaining in the stack, if not, jumping to step (8); (7) popping a data from the stack, setting the data as a starting position and then jumping to step (2); (8) end.

### BACKGROUND OF THE PRESENT INVENTION

1. Field of the Present Invention

The present invention relates to a shading method for a 3D graphic system, and more particularly, to a method for shading a triangle by using a tile as a basic processing unit.

2. Background of the Present Invention

FIG. 1 is a block diagram of a 3D graphic system in a computer system according to a prior art. Firstly, CPU (not shown) sends a 3D shading command 11 to a 3D graphic accelerator 12. The shading command 11 processed by the 3D graphic accelerator 12 is stored in a local frame buffer (LFB) 13. Normally, the 3D graphic accelerator 12 employs a DRAM (Dynamic Random Access Memory) as its local frame buffer 13. After that, the 3D graphic accelerator 12 sends the processed result to the Display 14 such that the processed result is displayed. In a 3D graphic system, objects shown on a screen are composed of a plurality of polygons and each polygon includes a plurality of triangles. In other words, the screen is composed of many triangles.

FIG. 2(A) and FIG. 2(B) are schematic diagrams of the pixel data of a triangle corresponding to its memory address according to the prior art. The LFB 13 stores the pixel data with scan line mode. Each block denotes a pixel and the number shown in the block represents the processing sequence of the 3D graphic accelerator 12. FIG. 2(A) illustrates the memory disposition scheme of the scan line mode. The thick line of the diagram denotes the boundary of the storage page of the memory. If one frame contains 1024×768 pixels and each pixel data has 16 bits, then the LFB 13 can store two scan lines in each storage page (4K bytes), and the numerals denote the scanning sequences in each storage page. When one storage page is scanned completely, the scanning operation of next storage page starts. In the embodiment shown in FIG. 2(B), a triangle is drawn column by column. Totally, it requires 6 storage pages to shade the triangle. Activation and pre-charge, which waste the bandwidth of memory, must be performed each time DRAM accesses a new storage page. Consequently, the utilization rate of the memory bandwidth can be improved effectively by reducing the number of storage pages covered by a triangle.

A conventional method using tiles to process a triangle is disclosed in the U.S. Pat. No. 5,914,722, “Memory efficient method for triangle rasterization”. The method shades a triangle onto a memory buffer tile by tile, and stores the addresses of the triangle positioned at the boundaries of tiles in a queue buffer (first-in-first-out, FIFO). Although this method can reduce the number of storage pages required for each triangle, the size of the associated queue buffer for storing the address pointer of the next tile to be shaded may be very large. FIG. 3(A) illustrates a memory disposition scheme for tile-based shading of the method. Each storage page is scanned in sequence as numbered in the diagram. FIG. 3(B) shows the disposition of a triangle corresponding to tiles according to the method. When the triangle is shaded in this way, the addresses of the points positioned at the boundary of storage pages (totally 10 points) need to be stored. As a result, when the triangle to be shaded is extremely large, the size of the associated queue buffer required increases dramatically. The worst situation is that the number of rows is the same as that of the display screen. For instance, a buffer storing 768 rows is required for a 1024×768 display screen.

### SUMMARY OF THE INVENTION

In view of the above, an object of the present invention is to provide a triangle shading method for a 3D graphic system, by which the waiting time while accessing a new storage page can be reduced.

Another object of this invention is to provide a triangle shading method for a 3D graphic system, which uses a tile as a basic processing unit and requires less memory space to store overhead data.

To achieve the above-mentioned objects, the present invention provides a triangle shading method for a 3D graphic system, which includes the steps of: (1) setting the leftmost vertex of the triangle to be drawn as a starting position; (2) defining the two adjacent edges of the starting position as adjacent edges; (3) setting the tile containing the starting position as a target tile, then setting the row of tiles starting from the target tile to the rightmost tile including pixels positioned in the triangle as a target tile row; (4) checking if the lower boundary and upper boundary of the target tile cross with the adjacent edges and pushing the address of the crossing point into a stack if there exists such crossing point; (5) checking if the upper boundary of the target tile crosses with the adjacent edges and pushing the address of the crossing pint into the stack if there exists such crossing point; (6) storing the data of the pixels, which are positioned in the triangle, of the target tile in memory; (7) checking if the target tile is the rightmost tile of the target tile row, if not, setting the target tile to be the next tile of the current target tile and then jumping to step (6); (8) checking if there are data remaining in the stack, if not, jumping to step (10); (9) popping a data from the stack, setting the data as a starting position and then jumping to step (3); (10) end.

### BRIEF DESCRIPTION OF THE DRAWINGS

FIG. 1 is a block diagram illustrating a prior art 3D graphics system.

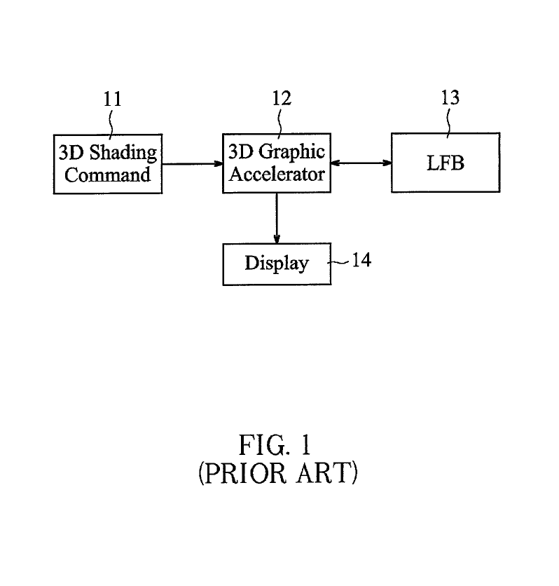

FIG. 2(A) illustrates the scan line mode memory disposition scheme in accordance with to the prior art.

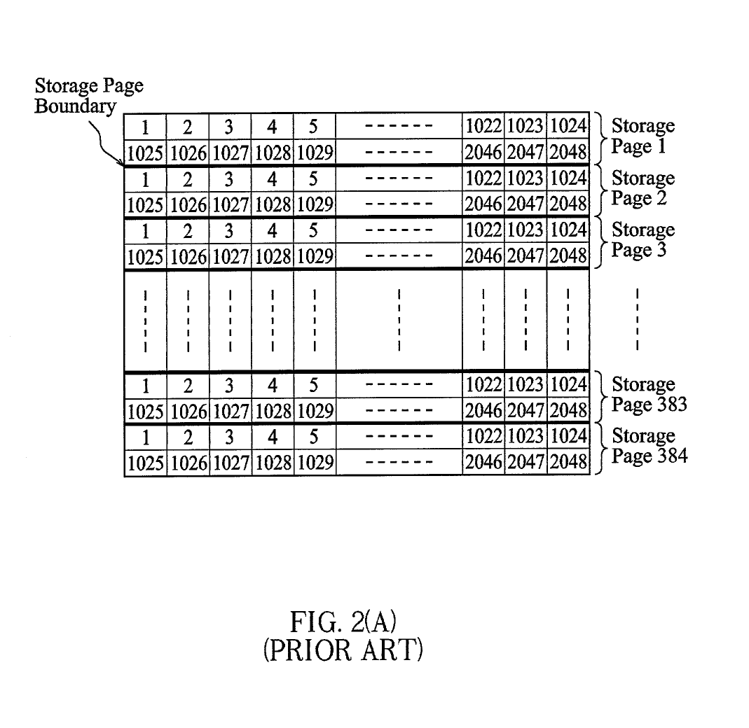

FIG. 2(B) is a schematic diagram illustrating the pixel mode of pixel shading process in accordance with the prior art.

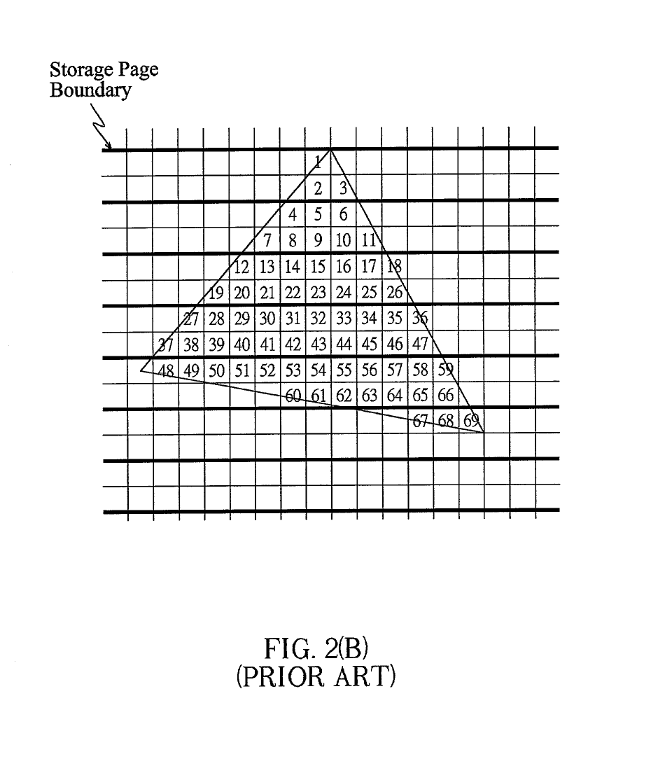

FIG. 3(A) illustrates the memory disposition scheme of the tile mode according to the prior art.

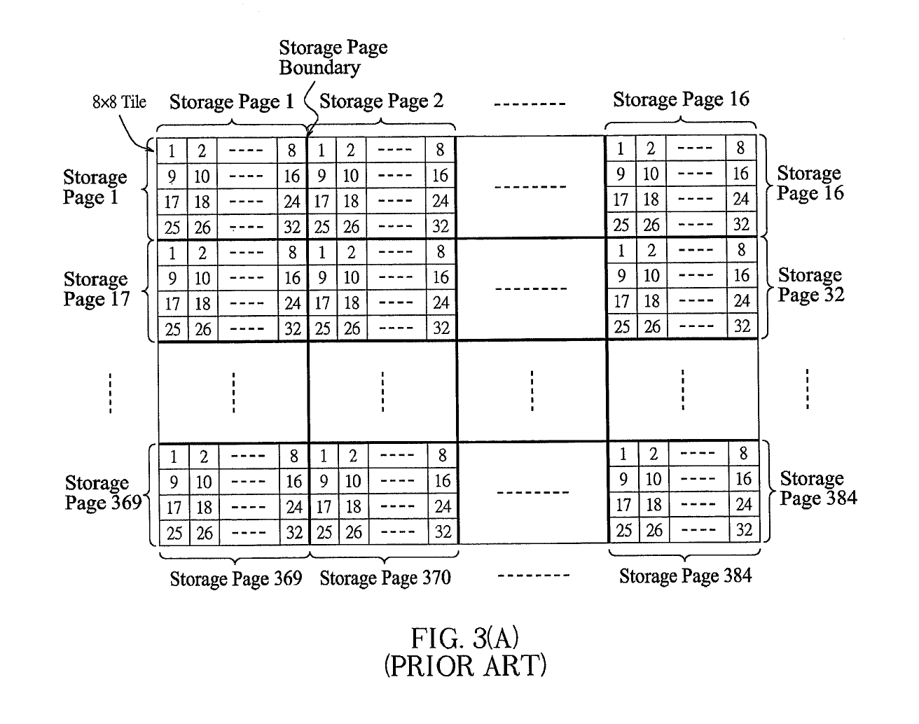

FIG. 3(B) is a schematic diagram illustrating the tile mode pixel shading process according to the prior art.

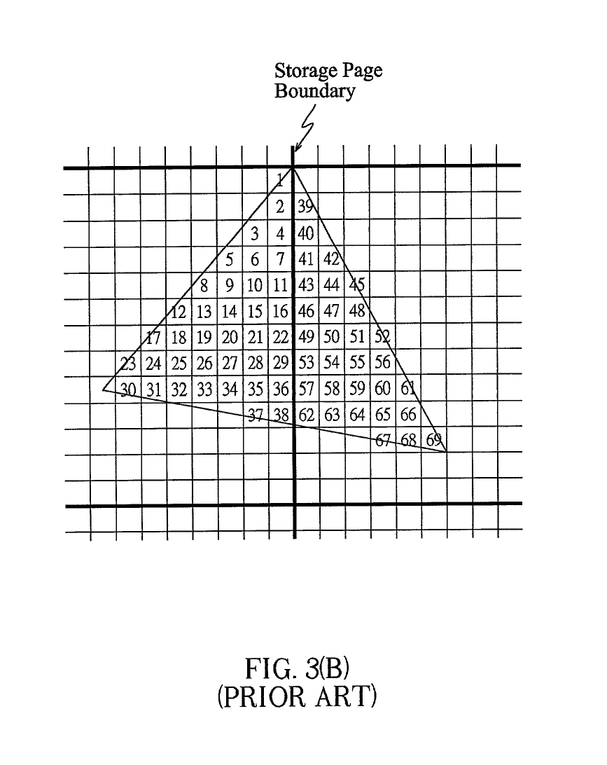

FIG. 4 is a schematic diagram of tile disposition in accordance with the present invention.

FIG. 5 shows a diagram of an 8×8 tile mode pixel shading process in accordance with the present invention.

FIG. 6 shows a flow chart of the triangle shading method for a 3D graphic system in accordance with the present invention.

FIG. 7 shows a diagram for tile mode pixel shading sequence in accordance with the present invention.

### DETAILED DESCRIPTION OF THE PREFERRED EMBODIMENTS

The triangle shading method for a 3D graphic system in accordance with the present invention, wherein a tile is used as a basic processing unit, is described in more details with the accompanying drawings.

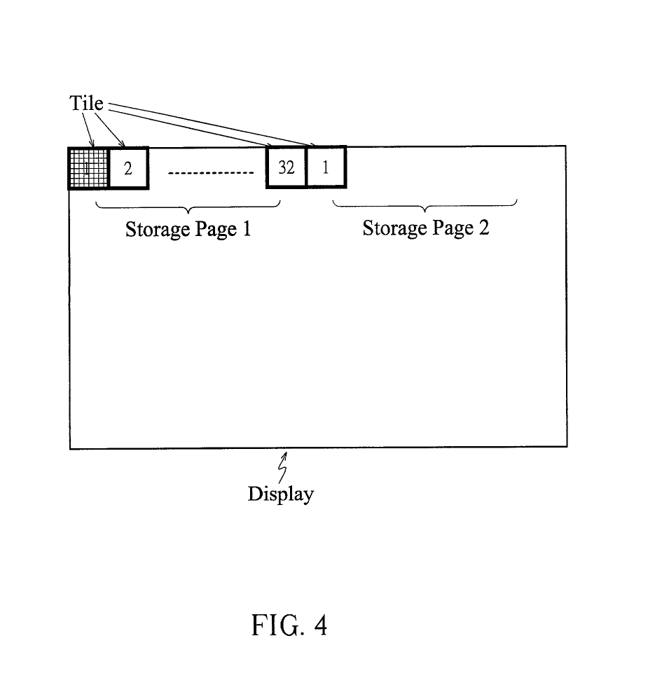

FIG. 4 is a schematic diagram that shows how the images are stored in memory by using a tile as a basic processing unit according to the present invention. As shown in FIG. 4, each tile is disposed in a pixel matrix with dimension 8×8. If each storage page is 4K Bytes in size and each pixel data is 16 Bits (2 Bytes) in size, then each storage page can store 32 tiles of pixel data. The size of a tile is not limited to 8×8 pixel matrix, it can be other different size. As shown in FIG. 4, tiles are stored in a storage page of the memory one by one in horizontal direction. They may also be stored in a storage page of the memory one by one in vertical direction.

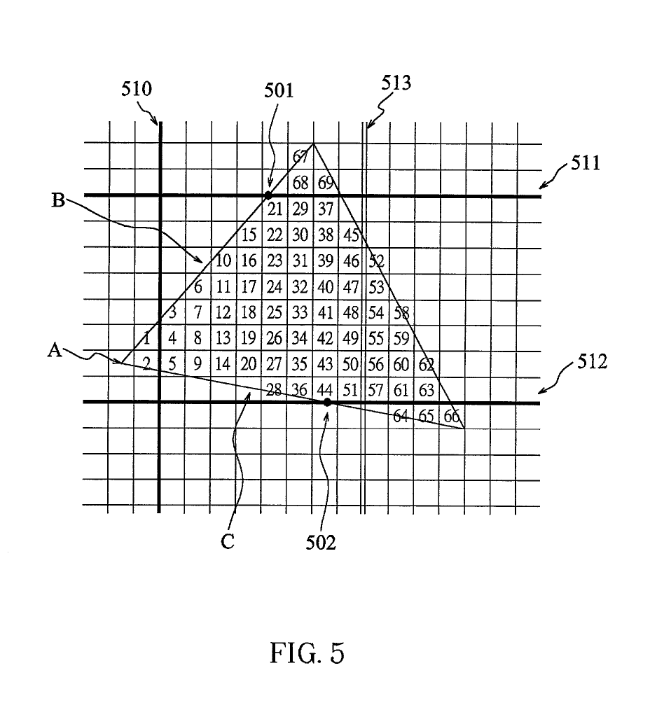

FIG. 5 is a schematic diagram that shows a triangle and the corresponding memory disposition. In this embodiment, the dimension of a pixel matrix for each tile is 8×8 and each block denotes one pixel. As shown in FIG. 5, the thick lines 510, 511, 512 denote the boundary lines of tiles and storage pages, the double line 513 denotes boundary line of tiles. In this way, the triangle can be stored in four storage pages. As a comparison, six storage pages are required for conventional method. As a result, the waiting time for accessing new storage pages can be reduced in the process of shading (saving) a triangle. The utilization rate of memory bandwidth thus can be improved. The numerals shown in the triangle of this diagram represent the sequence for saving each pixel when the triangle is shaded.

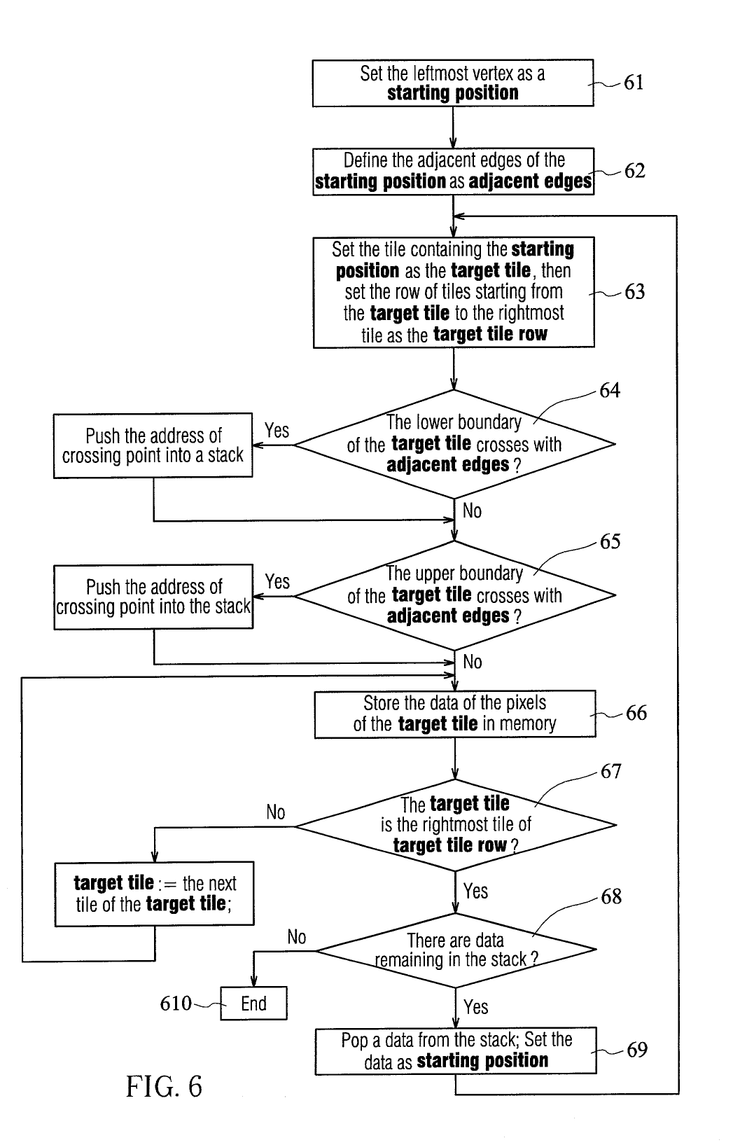

FIG. 6 shows a flow chart of the triangle shading method for a 3D graphic system in accordance with the present invention, wherein data are stored in accordance with the rules illustrated by FIG. 4. The steps of the method are as follows:

Step 61: Set the leftmost vertex of the triangle to be drawn as a starting position;

Step 62: Define the two adjacent edges of the starting position as adjacent edges;

Step 63: Set the tile containing the starting position as a target tile, then set the row of tiles starting from the target tile to the rightmost tile including pixels positioned in the triangle as a target tile row;

Step 64: Check if the lower boundary of the target tile crosses with the adjacent edges and push the address of the crossing point into a stack if there exists such crossing point;

Step 65: Check if the upper boundary of the target tile crosses with the adjacent edges and push the address of the crossing pint into the stack if there exists such crossing point;

Step 66: Store the data of the pixels, which are positioned in the triangle, of the target tile in memory;

Step 67: Check if the target tile is the rightmost tile of the target tile row, if not, set the target tile to be the next tile of the current target tile and then jump to step (66);

Step 68: Check if there are data remaining in the stack, if not, jump to step (10);

Step 69: Pop a data from the stack, set the data as a starting position and then jump to step (3);

Step 610: End.

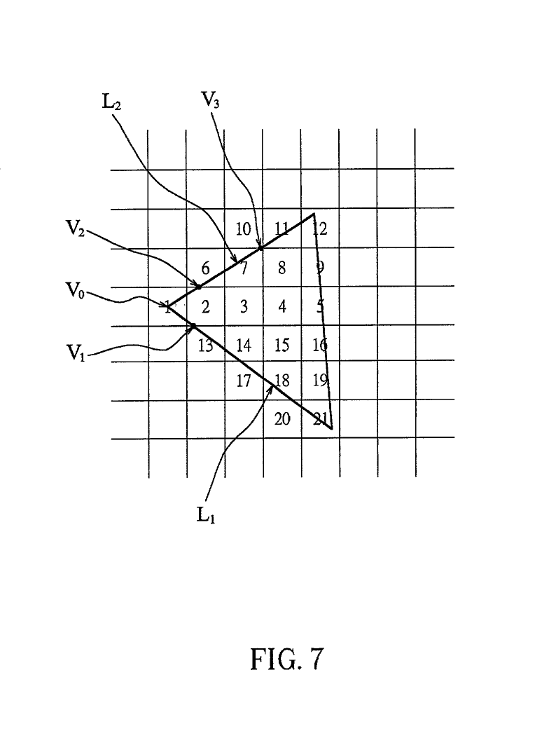

FIG. 7 illustrates the way for shading a triangle having a relatively large area, wherein each block denotes one tile. The vertical and horizontal lines represent the boundary lines of tiles. With reference to the flow chart of FIG. 6, the triangle of FIG. 7 is shaded as follows.

1. Set the leftmost vertex V0 as the starting position;

2. Define the two adjacent edges L1, L2 of the starting position V0 as the adjacent edges;

3. Set the tile containing the starting position (tile 1) as the target tile, then set the row of tiles starting from the target tile to the rightmost tile including pixels positioned in the triangle as the target tile row (tiles 1, 2, 3, 4, 5);

4. Check if the lower boundary of the target tile crosses with the adjacent edges and push the address of the crossing point into a stack if there exists such crossing point (when tile 2 is processed, the address of vertex V1 is pushed into the stack);

5. Check if the upper boundary of the target tile crosses with the adjacent edges and push the address of the crossing point into the stack if there exists such crossing point (when tile 2 is processed, the address of vertex V2 is pushed into the stack);

6. Store the data of the pixels, which are positioned in the triangle, of the target tile in memory;

7. Check if the target tile is the rightmost tile of the target tile row, if not, set the target tile to be the next tile of the current target tile and then jump to step (6);

8. Check if there are data remaining in the stack, if not, jump to step (10);

9. Pop a data from the stack, set the data as a starting position and jump to step (3);

10. End.

(At first, the target tile is tile 1 and the target tile row is the row of tiles consisting of tiles 1, 2, 3, 4, 5. Since tile 1 is not the rightmost tile of the target tile row, the target tile is set to be tile 2 after the data of the pixels, which are positioned in the triangle, of tile 1 are stored in memory. Then the addresses of vertices V1, V2 are pushed into the stack. In the meantime, since tile 2 is not the rightmost tile of the target tile row, the target tile is set to be tile 3 after the data of the pixels, which are positioned in the triangle, of tile 2 are stored in memory. Next, since tile 3 is not the rightmost tile of the target tile row, the target tile is set to be tile 4 after the data of the pixels, which are positioned in the triangle, of tile 3 are stored in memory, and the like. The same procedure is repeated until the target tile becomes tile 5, which is the rightmost tile of the target tile row. The next procedure is to check if there are data remaining in the stack, and pop out the address of the vertex V2 from the stack. The address of the vertex V2 is then set as the starting position and similar procedures are repeated. Tile 6 is thus processed and then tile 7 is processed. The address of vertex V3 is pushed into the stack (there is still one data, the address of vertex V1, remaining in the stack) when tile 7 is the target tile. Subsequently, tiles 7, 8 are processed sequentially following the same procedure.)

According to the above descriptions, when a triangle is shaded, at most the associated data of two intersections need to be stored. Therefore, the size of the stack for storing the data of intersections and the time for accessing the stack can be reduced.

Since the above embodiments are described only for examples, the present invention is not limited to the above embodiments, and various modifications or alternations can be easily made therefrom by those skilled in the art without departing from the spirit of the present invention.

What is claimed is:

1. A triangle shading method for a 3D graphic system using a tile as a basic processing unit comprising:
(1) setting the leftmost vertex of the triangle as a starting position;
(2) defining the two adjacent edges of the starting position as adjacent edges;
(3) setting the tile containing the starting position as a target tile, then setting the row of tiles starting from the target tile to the rightmost tile including pixels positioned in the triangle as a target tile row;
(4) checking if the lower boundary of the target tile crosses with the adjacent edges and pushing the address of crossing point into a stack if there exists such crossing point;
(5) checking if the upper boundary of the target tile crosses with the adjacent edges and pushing the address of crossing pint into the stack if there exists such crossing point;
(6) storing the data of the pixels, which are positioned in the triangle, of the target tile in memory;
(7) checking if the target tile is the rightmost tile of the target tile row, if not, setting the target tile to be the next tile of the current target tile and then jumping to step (6);
(8) checking if there are data remaining in the stack, if not, jumping to step (10);
(9) popping a data from the stack, setting the data as a starting position and then jumping to step (3);
(10) end.

2. The triangle shading method of claim 1, wherein the tile is a pixel matrix.

3. The triangle shading method of claim 1, wherein the memory includes a plurality of storage pages, each of the storage pages further comprises a plurality of tiles, and the plurality of tiles make up a triangle.
